(19) United States
(12) Patent Application Publication
(10) Pub. No.: US 2011/0174439 A1
(43) Pub. Date: Jul. 21, 2011

(54) VAPOR DISPERSIBLE PLASTIC FILM WITH PAINT ADHERENCE & CLING

(75) Inventor: Graham Chapman, Niagara-On-The-Lake (CA)

(73) Assignee: Petoskey Plastics, Inc., Petoskey, MI (US)

(21) Appl. No.: 13/039,939

(22) Filed: Mar. 3, 2011

Related U.S. Application Data
(63) Continuation of application No. 12/301,413, filed on May 5, 2009.
Application No. 12/301,413 is a continuation-in-part of application No. PCT/US06/19248, filed on May 18, 2006.
(60) Provisional application No. 60/682,874, filed on May 18, 2005.

(51) Int. Cl. B32B 5/16; B32B 5/00; B32B 27/08

(52) U.S. Cl. 156/334; 428/323; 428/339; 428/220; 428/330; 428/331; 428/324

(57) ABSTRACT

A co-extruded plastic film comprises an outer layer formed of a high density polymer or co-polymer having a high surface energy, such as a medium molecular weight high density polyethylene that is corona treated or includes a relatively polar polymer, a core layer preferably formed of a polyolefin, which can include linear low density polyethylene or a foamed polymer preferably produced by an endothermic blowing agent, and an inner layer formed of a polymer having good cling properties that includes a filler of sufficiently large particle size and in a sufficiently large amount that vapors can escape laterally from under the film. This film allows vapors to disperse and can also be moisture absorbent and vapor permeable. The film also has the benefit that one surface has high paint adherence and the opposite surface clings to a substrate while having good lateral transmissivity of vapors.

### CROSS REFERENCE TO RELATED APPLICATIONS

This is a continuation of Applicant's co-pending U.S. patent application Ser. No. 12/301,413, filed May 5, 2009, which is a U.S. National Stage Entry under 35 USC 371 of PCT Application No. PCT/US2007/063695, filed Mar. 9, 2007, which is a continuation-in-part of PCT Application No. PCT/US2006/019248, filed May 18, 2006, which claims the benefit of U.S. Provisional Application No. 60/682,874, filed May 18, 2005, which applications are incorporated herein by reference.

### BACKGROUND OF THE INVENTION

The present invention relates to a plastic film for masking and protecting a vehicle that minimizes bloom when used on a wet vehicle, while providing desirable cling to the vehicle and desirable paint adherence.

The art of modifying and controlling the vapor permeability of thin polymer films is well established in the plastics industry. This control is mostly concerned with modifying the transmission, through the film, of small molecules, such as those of water, carbon dioxide and oxygen, and is generally confined to a temperature range from 4° C. to around human body temperature of 37° C. However, for certain applications, such as those involving the curing of paints, it is important to control vapor transmission through plastic film at temperatures around 60° C. The vapor molecules involved, apart from moisture, tend to be low molecular weight organic compounds used as solvents.

The use of a multi-layer plastic film for paint masking and protection of a vehicle has already been described in Applicant's U.S. patent application Ser. No. 10/784,857, now abandoned, which is incorporated herein by reference. This film has the benefits of paint adherence (to catch the overspray from the spraying process) and cling (to hold the film in place on the vehicle). However, when the film is placed on a damp or wet vehicle after the curing process, at around 60° C., patches referred to as “ghosting” or “bloom” can develop on the painted surface of the vehicle. These blemishes are unacceptable to the consumer and can result in considerable cost to remedy.

There is therefore a need to provide a film that has all the benefits of the aforementioned protective film together with the benefit of preventing “bloom” when used on a damp or wet vehicle.

Prior attempts to remedy the problem of bloom have included films that permit vapor to pass through the films. These have had limited success. One prior film that has had some success in reducing bloom is a three layer film with identical inner and outer layers, each layer being formed of a combination of low density polyethylene (LDPE) and linear low density polyethylene (LLDPE), wherein a particulate material is incorporated in the inner and outer layers of the film. This film is identical on both sides so that either side of the film can be used as a body contact surface. However, this film has substantially less satisfactory cling characteristics compared with a desirable film that does not transmit vapors.

An object of the present invention is to provide a film that has good vapor dispersing characteristics and that retains good cling, paint adherence, and other physical characteristics.

A relatively new method to measure the performance of different films with respect to “bloom” has been developed and is used herein. This consists of painting a metal sheet with a typical automotive paint—two layers of etching undercoat, three layers of colored basecoat and two layers of clearcoat. This metal sheet is then sprayed with moisture from an atomizing bottle and strips of the plastic films being tested are then fixed to the surface. The metal sheet is placed in an oven at 60° C. for 30 minutes. After cooling, the film is stripped off and the amount of “bloom” is estimated. A scale from 0 to 100% is used to describe the amount of bloom under each of the strips. 100% refers to a surface where the paint is still visible as 100% and there is no ghosting. 0% refers to a surface on which it is totally “bloomed”. Simple polyethylene film gives a result between 0 and 30%. A good film for damp vehicles gives a result between 75 and 100%.

### BRIEF SUMMARY OF THE INVENTION

The present invention is an improved paint masking material that disperses vapors while still retaining good cling and paint adherence characteristics. The invention comprises a co-extruded plastic film having a relatively thin inner layer comprising a polyethylene or polypropylene (or other polyolefin) that has good static or physical cling properties, in which a substantial quantity of a relatively large particle size filler material is incorporated, in combination with an outer layer that is treated or incorporates a polar material so as to improve paint adherence. At least one layer, preferably at least the outer layer, comprises a high density polyethylene (or other high density polyolefin). The high density material has the beneficial effect of producing or retaining an enhanced static cling in the inner layer. This enhanced cling in the inner layer offsets to a substantial amount a decrease in cling that would otherwise be produced by the bumpy surface contour produced by the incorporation of a substantial quantity of large particle size filler material in the inner layer. The film can have a middle or core layer that improves the physical characteristics of the film.

The filler is added to the inner layer in contact with the vehicle to provide a rough surface to the film, thereby preventing closure of the film surface over the vehicle and entrapping the volatiles under the film. In addition, a desiccant can be included in this layer to help absorb the moisture. A desiccant also can be used as the filler material.

The fillers in the film help raise the lateral vapor transmission rate of the film. This helps prevent the entrapment of volatiles under the film during curing of the paint. Fillers having a median particle size of at least about 5 microns and preferably at least about 8-10 microns (a “coarse” particle size) are preferred, although a median particle size of at least 4 microns works. Known materials with good static or physical cling properties that can be used in the inner layer include high density polyethylene (HDPE) and linear low density polyethylene (which includes ultra linear low density polyethylene, ULLDPE). Polypropylene and other polyolefins that have comparable cling properties also can be used. LLDPE is desirable because it also is inexpensive and has desirable strength, tear and other physical characteristics. Embossing the inner layer also can be employed to provide a rough surface to enhance lateral vapor transmission. The filler can be treated with a conditioning agent such as stearic acid or the like to improve compatibility between the filler and the inner layer, which improves the physical characteristics of the filled film.

The middle or core layer in the preferred invention is selected for its contribution to the physical characteristics of the film. Polyethylene or polypropylene or other comparable polyolefins having good tear, strength and penetration properties can be used. The core layer can be foamed to increase film porosity (the ability of vapor to pass through the film), but this should not be necessary with the preferred films having desirable lateral transmissivity characteristics. If increased film thickness or increased porosity is desired, these can be achieved by foaming the film. Foaming of thermoplastic polymers in film blowing has been described previously, e.g. Boyd et al. U.S. Pat. No. 4,657,811, but in the present invention foaming, if desired, is achieved by incorporating a chemical blowing agent, preferably an endothermic blowing agent, with the extrusion melt.

To meet the physical requirements of the film to provide improved paint adherence to the outer surface of the film and to enhance the cling of the film to the vehicle surface, the outer surface desirably comprises a high density polyethylene, preferably medium molecular weight high density polyethylene (MMW HDPE). High molecular weight high density polyethylene (HMW HDPE) also is satisfactory, although MMW HDPE appears to provide better paint adherence and is therefore preferred. Other high density polyolefins also can be used. A high density polypropylene, if available, could be used. The outer surface of the film also can be treated by corona treating or other process to increase the polarity of the film to a level greater than 35 dynes/cm and preferably to 45 or 50 dynes/cm or more. This further enhances the adherence of paint to the film. If desired, a relatively polar polymer, such as ethylene vinyl acetate (EVA) or similar polar polymer can be incorporated into the outer layer in order to increase the polarity of the outer layer. Incorporating EVA or other polar polymer into the outer layer can be used as an alternative to corona treating as a means for increasing the polarity of the outer surface of the film, although they can be used together.

These and other features, objects, and benefits of the invention will be recognized by one having ordinary skill in the art and by those who practice the invention, from the specification, the claims, and the drawing figures.

### BRIEF DESCRIPTION OF THE SEVERAL VIEWS OF THE DRAWING

FIG. 1 is a cross sectional view of a three layer plastic film in accordance with the present invention.

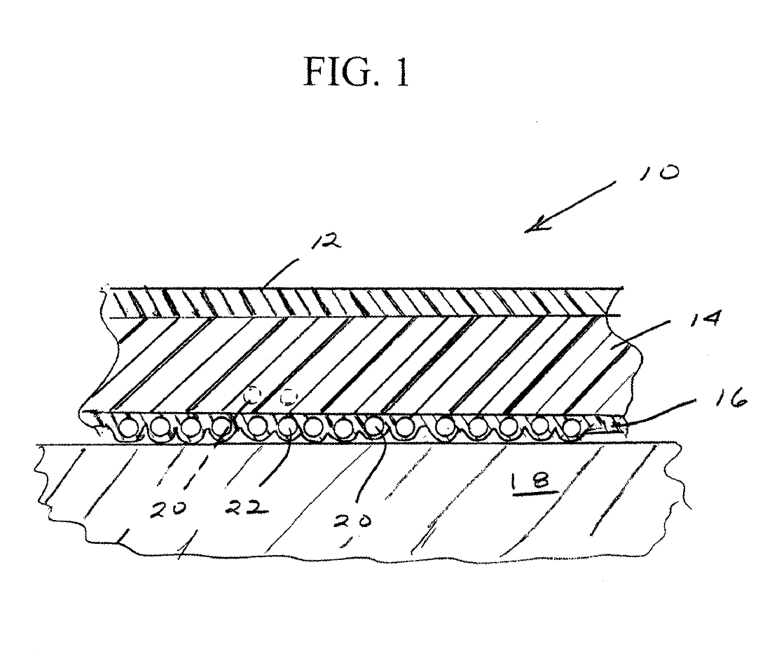

### DETAILED DESCRIPTION OF THE INVENTION

The films 10 described are made by thermoplastic co-extrusion of polyolefins using the established blown film process or film casting. The “weight” thickness of the film is between 0.3 mils and 2.5 mils, although, either because of the foaming process, the use of particulate fillers or embossing, the measured caliper thickness of the film can be as high as 4.5 mil. Due to this variability of caliper measurement of films containing particulate filler, film thicknesses are expressed as a weight thickness, given the known composite density of the film and particulate materials. It is generally desirable to make a film as thin as possible, in order to minimize film cost, which is largely controlled by material costs. Minimum film thickness is primarily limited by manufacturing capabilities. At the present time, the minimum film thickness possible for a three layer film with existing equipment is about 0.3 mils to about 0.5 mils. A thinner film would be expected to work if it could be made. Maximum film thickness is controlled primarily by the cost of the additional material, although increased film stiffness also can become a factor with thick films. A film thickness in excess of about 0.8 mils should not be necessary and would be more expensive. However, a maximum film thickness for a three layer film of up to about 2.5 mils would be satisfactory. A three-layer film is described herein, but a film having a greater number or a smaller number of layers can be employed. In a three layer film, the thickness range of the inner and outer layers can vary between about 0.05 and 0.5 mils, and the core layer thickness can vary between about 0.2 and 1.5 mils.

The main thermoplastic polymers used in the film layers are selected for physical properties of the finished film and cost. Typically polyolefins are used from the groups comprising low density polyethylene, medium density polyethylene, high density polyethylene, linear low density polyethylene, metallocene low density polyethylene, homopolymer polypropylene, copolymer polypropylene and thermoplastic olefins.

The outer layer 12 may incorporate a relatively polar polymer with surface energy significantly higher than a pure polyolefin, such as ethylene vinyl acetate (with a vinyl acetate content from 3% to 28%), ethylene vinyl alcohol (with an ethylene content between 27% and 48%), poly-(ethylene acrylic acid), poly-(ethylene methyl acrylic acid), neutralized poly-(ethylene acrylic acid), poly-(ethylene methylacrylate), poly-(ethylene ethyl acrylate). However, a corona treated high density polyethylene provides sufficient surface energy for paint adherence. Medium molecular weight HDPE is preferred, but high molecular weight HDPE is satisfactory.

The outer layer can also be treated to produce a relatively higher surface energy, typically by corona treatment (ionization of the air caused by the stress of high voltage impressed across an insulator), but other methods can be used, e.g. flame treatment. The level of treatment is to a level greater than 35 dynes/cm and can be as high as 50 dynes/cm or higher. A level of greater than 45 dynes/cm is especially desirable. Corona treatment is generally used when EVA or other polar polymer is not included in the outer layer. The outer layer is typically about 20%-30% of the weight thickness of the film but could be about 10-40% of the thickness. A minimum of about 10% is employed in order to ensure that the film completely covers the outer layer. Maximum thickness is restricted principally to reduce cost.

The core layer 14 is usually the main structural layer, typically being as high as 50% of the structure's weight. In addition to the polyolefin selected, some recycled resin, as high as 50%, can be incorporated in this layer.

The core can be formed of polyethylene or polypropylene or other comparable polyolefin. HDPE can be used. The core also can desirably be formed from LLDPE. This provides good strength and tear characteristics and is cost effective. The core can be formed from other polymers and can be foamed to increase the vapor permeability of the overall structure. Foaming during extrusion can be achieved by several means, either chemical or physical. In chemical foaming the foaming agent decomposes or reacts at a particular temperature in the extrusion process. This can either be exothermic, such as the release of nitrogen from the decomposition of azodicarbonamide, or endothermic, such as the release of carbon dioxide from the reaction of sodium bicarbonate and an acid. For physical foaming the foaming agent is directly injected into the polymer melt. The compounds injected can be either liquids, such as pentane or butane, or gases, such as carbon dioxide or nitrogen. The disadvantage of the injection method is that it requires machinery modification, so the method used in the present invention is the incorporation of a chemical blowing agent, particularly an endothermic blend.

Endothermic blowing agents are available from various suppliers, such as Ampacet's 703061-H, which contains 50% foaming agent and generates gas in the temperature range of 192-215° C. This range is typically encountered during polyolefin extrusion. The amount of the concentrate added can be between 0.1% and 2.0%. Even at the lower level an increase in vapor permeability is observed.

Because of the effectiveness of the lateral vapor transmissivity of the film of the present invention, foaming the core has not been found to be necessary.

The inner layer 16 of the plastic film structure is the one that is in contact with the vehicle 18 or other substrate and therefore has most effect on the generation of “bloom” or “ghosting” when a damp vehicle has the film applied and is sent for curing. With a simple polyethylene inner layer, a damp vehicle is covered using the film and new paintwork is cured at 60° C. There are light patches visible where the moisture had been. This is the problematic “ghosting” or “blooming”. In the present invention, this simple inner layer is modified by one or a combination of ingredients.

To provide cling to the vehicle surface, the inner layer is formed of a polyethylene or polypropylene, or other polyolefin that exhibits good physical cling or static cling properties. HDPE has good static cling properties. An inner layer formed from a material that includes linear low density polyethylene (LLDPE) (including ultra linear low density polyethylene (ULLDPE)) has good physical cling properties. One of the features of the present invention is that when one of the layers of the film employs a high density polyolefin, such as high density polyethylene, the cling at the inner layer of the film is enhanced and remains relatively high even in the presence of a substantial amount of particulate material in the inner layer. Even when the inner layer is formed of a material having a lower density than HDPE, the presence of HDPE in an outer layer induces increased static cling in the inner layer. The inner layer comprises about 10-40% of the total thickness of the film and preferably about 30% of the total thickness.

To provide lateral vapor transmissivity, a filler 20, such as calcium carbonate, talc, diatomaceous earth and other silicates and silicas is incorporated in the inner layer. The filler needs to be of relatively large particle size in order to impart sufficient surface “roughness” to the film so as to permit lateral escape of the vapor, the lateral transmissivity of the film. An average particle size of about 4-20 microns will work. A median particle size of at least 5 microns and desirably at least 8 microns is preferred. An especially preferred particle size has a median particle size of around 8-10 microns, with a cut off of 17 to 80 microns. The amount added is a compromise between improving the “roughness” of the film and the negative effect on the physical characteristics of the film. The range of addition is 5 to 50% of the concentrate (which contains 50 to 75% filler additive in a polymer carrier). In the successful example referred to below, wherein the inner layer is about 30% by weight of a film about 0.6 mils thick, the filler concentrate comprises about 40% of the inner layer, with the concentrate comprising about 65% particulate material, which means that the inner layer is about 26% particulate filler material. It is desirable to include about 20-30% of this particulate material in a film wherein the inner layer is 0.5-0.8 mils and preferably 0.6 mils thick. When the median particle size of the filler is greater than the thickness of the inner layer, this ensures that the inner layer will have a bumpy, modified surface with a minimum of filler. This in turn helps diffusion of the vapors from the painted vehicle surface, which vapors include not only water vapor but also vapors from volatile solvents from the paint, typically low molecular weight organics. It may be desirable to increase the total amount of filler in the inner layer if a smaller median particle size filler is used or if a thicker inner layer is used in the film. Because of the improved cling provided by the use of a higher density material in one or more layers, particularly in an outer layer, the size and quantity of filler in the inner layer can be high enough to provide sufficient vapor transmissivity to virtually eliminate bloom without reducing cling to an unsatisfactory level. In addition, by incorporating the filler only in the relatively thin inner layer, the cost and other physical drawbacks associated with the incorporation of a substantial quantity of filler in the film are avoided. The middle layer and outer layer can retain their strength without filler, while maximizing the effect of filler in the inner layer. A filler can be added to the middle layer, but this has been found to be unnecessary to produce adequate vapor transmissivity in the film.

In addition to a filler, a dessicant 22 can be added to absorb some of the moisture vapor. This is typically in the form of a calcium oxide concentrate, such as Ampacet's 101499 containing a nominal 50% calcium oxide. At the curing temperature there is a rapid irreversible reaction whereby the calcium oxide reacts with the moisture vapor to form calcium hydroxide. The dessicant also can serve as a filler and will impart a surface roughness that enhances lateral escape of vapor.

The inner layer also can be embossed in order to increase the roughness and vapor transmissivity of the inner layer.

Another feature of the invention is that a very low density polyethylene or an ultra linear low density polyethylene can be added to any or all of the layers, up to a level of 50%, in order to increase the porosity of the layer, if this is desired or necessary. The increased porosity and vapor permeability of the layer and the film facilitates the transport of molecules through the film.

Also, to improve the porosity of the film, during the film blowing process, the blow up ratio is more than 3.5:1 and even more than 4.5:1. When this is done with a film containing the filler particulates the vapor transmission rate is increased.

### EXAMPLES

Film trials were carried out on a 3-layer Alpine extrusion line with the following extruders:

| | | |
|---|---|---|
| 75 mm (3 in.) | 24:1 | Grooved feed |
| 65 mm (2.6 in.) | 21:1 | Grooved feed |
| 50 mm (2 in.) | 21:1 | Grooved feed |

Die diameter: 200 mm (7.9 in.)

Structures run by weight 10:50:40, inside:middle:outside

Three layer films were blown with the following constructions:

| | Outer | Middle | Inner |
|---|---|---|---|
| A | HMW HDPE | HMW HDPE | HMW HDPE |
| B | 20% EVA | HMW HDPE | HMW HDPE |
| | 80% MMW HDPE | | |
| C | 20% EVA | 1% Blowing Agent | HMW HDPE |
| | 80% MMW HDPE | 99% HMW HDPE | |
| D | 20% EVA | 1% Blowing Agent | 20% Calcium Carbonate |
| | 80% MMW HDPE | 99% HMW HDPE | 40% ULLDPE |
| | | | 40% HMW HDPE |

The films were run with a blow-up ratio of 4.5:1 and the physical test results were:

| | Gauge Mil | WVTR g · m.⁻² day⁻¹ | OTR g · m⁻² day⁻¹ |
|---|---|---|---|
| A | 0.8 | 23.3 | 12153 |
| B | 0.5 | 23.3 | 9770 |
| C | 0.4 | 30.4 | 10439 |
| D | 0.5 | 30.2 | 10447 |

The bloom, measured according to the test method described above, of these films was:

| | Bloom Rating |
|---|---|
| A | 35 |
| B | 40 |
| C | 73 |
| D | 85 |

These results demonstrated that increasing the vapor transmission rates helped prevent the development of “ghosting” or “bloom” on the painted surface that had moisture before application of the film and curing.

Further tests including desiccant or coarse particle sized fillers (measured in concentrate form, which contains about 65% filler) in one or two layers resulted in the following values:

| Inner layer | Core layer | Outside layer | Bloom rating |
|---|---|---|---|
| 40% coarse particle | 20% coarse | 100% HDPE | 100 |
| sized filler | particle size filler | | |
| 60% MMW HDPE | 80% HDPE | | |
| 40% desiccant (CaO) | 100% HDPE | 100% HDPE | 100 |
| 60% MMW HDPE | | | |

As indicated, these tests demonstrate that bloom can be effectively eliminated by the incorporation of a large quantity of a coarse particle size filler in the inner layer alone and that the incorporation of filler in other layers is not necessary.

Tests also were performed on a film having an outside layer composed of corona treated 100% MMW HDPE, a core layer of 100% LLDPE, and an inner layer composed of 60% LLDPE and 40% coarse particle size filler concentrate (which comprises about 65% particulate having a median particle size of 8-10 microns, thus contributing about 26% particulate material to the composition). The total film thickness was about 0.6 mils thick, with the outer, core, and inner layers comprising about 20%, 50%, and 30%, respectively, of the film thickness. The results with this film indicated superior film cling and paint adherence and a 100 bloom rating. The cost and physical characteristics of this film (including cling) also were superior. The same film, except that HMW HDPE was used in the outer layer, produced substantially the same bloom and cling properties but not quite as good paint adherence.

It will be understood by one having ordinary skill in the art and by those who practice the invention that various modifications and improvements may be made without departing from the spirit of the disclosed concept. Various relational terms, including inner and outer for example, are used in the detailed description of the invention and in the claims only to convey relative positioning of various elements of the claimed invention. The scope of protection afforded is to be determined by the claims and by the breadth of interpretation allowed by law.

1. A method for masking a painted surface adjoining an unpainted surface on a product so as to protect the painted surface from paint overspray during spray painting while minimizing bloom or ghosting caused by water vapor trapped between the masking material and the painted surface, the method comprising applying to the surface a masking material in the form of a self-adhering multi-layer co-extruded plastic film having lateral vapor dispersion characteristics, the film comprising an inner layer comprising one or more of low density or linear low density polyethylene or polypropylene, such that the inner layer has inherent physical cling properties, the inner layer having a thickness of 0.05 mil to 0.5 mil by weight measurement and incorporating a particulate filler in an amount of 30% to 50% by weight, the filler having an average particle size of 8 to 10 microns, the particle size and quantities of the particulate material in the inner layer in relation to the thickness of the inner layer being such as to form lateral vapor transmission channels on an inner surface of the film, one or more outer layers, on an outer side of the film, at least one outer layer comprising a high density polyethylene having static cling properties, the layers being formed together such that the static cling properties in the outer layer are transmitted through the inner layer to the inner surface of the film so as to augment the physical cling properties of the inner layer, the combination of the static cling and physical cling properties at the inner surface of the film serving to at least partially offset any reduced physical cling properties due to the roughness of the inner layer resulting from the incorporation of particulate material therein.

2. The method according to claim 1, wherein the inner layer has a thickness of 0.18 mils.

3. The method according to claim 1, wherein the inner layer incorporates the particulate filler in an amount of 40% by weight.

4. The method according to claim 1, wherein the average particle size exceeds the thickness of the inner layer by weight measurement.

5. A means for masking a painted surface during painting of an adjoining surface, comprising a vapor dispersible plastic film, the film comprising an inner layer comprising one or more of low density or linear low density polyethylene or polypropylene, such that the inner layer has inherent physical cling properties, the inner layer having a thickness of 0.05 mil to 0.5 mil by weight measurement, the inner layer incorporating a particulate filler, in an amount of 30% to 50% by weight, the filler having an average particle size of 8 to 10 microns, the particle size and quantities of the particulate material in the inner layer in relation to the thickness of the inner layer being such as to form lateral vapor transmission channels on an inner surface of the film, one or more outer layers, on an outer side of the film with at least one outer layer comprising a high density polyethylene having static cling properties, the layers being formed together such that the static cling properties in the outer layer are transmitted through the inner layer to the inner surface of the film, the combination of the static cling and physical cling properties at the inner surface of the film serving to at least partially offset any reduced physical cling properties due to the roughness of the inner layer resulting from the incorporation of particulate material therein.

6. A vapor dispersible plastic paint masking film comprising:
an outer layer with a thickness between 0.05 mil and 0.5 mil comprising high density polyethylene, the outer layer including at least one of a surface treatment or a polar polymer that improves paint adherence thereto;
a core layer with a thickness between 0.2 mil and 1.5 mil comprising at least one of polyethylene and polypropylene; and
an inner layer with a thickness between 0.05 mil and 0.5 mil by weight measurement comprising one of linear low density polyethylene and another polyolefin having good static cling or physical cling properties, the inner layer further including a particulate filler having a median particle size that increases the roughness of the film.

7. The film according to claim 6, having an overall thickness of 0.3 mil to 2.5 mil by weight measurement.

8. The film according to claim 6, wherein the inner layer comprises linear low density polyethylene.

9. The film according to claim 6, wherein the outer layer comprises up to 50% by weight of a polar polymer.

10. The film according to claim 9, wherein said polar polymer comprises one of ethylene vinyl acetate with a vinyl acetate content from 3 to 28%, ethylene vinyl alcohol with an ethylene content between 27 and 48%, poly-(ethylene acrylic acid), poly-(ethylene methyl acrylic acid), neutralized poly-(ethylene acrylic acid), poly-(ethylene methylacrylate), and poly-(ethylene ethyl acrylate).

11. The film according to claim 6, wherein the outer layer is corona treated to a level greater than 35 dynes/cm.

12. The film according to claim 6, wherein the filler comprises a sufficient quantity of particles having a particle size greater than the thickness of the inner layer that the film has a bloom rating of about 100.

13. The film according to claim 12, wherein the filler comprises one or more components selected from the group consisting of calcium carbonate, talc, diatomaceous earth, mica and precipitated silicas.

14. The film according to claim 1, wherein the inner layer includes between 3% and 50% of the particulate filler, which comprises one or more components selected from the group consisting of calcium carbonate, talc, diatomaceous earth, mica and precipitated silicas.

15. The film according to claim 1, wherein the filler composes between 20% and 30% of the inner layer and comprises particles having a median particle size greater than the thickness of the inner layer by weight measurement.

16. The film according to claim 15, wherein the median particle size is at least 5 microns.

17. The film according to claim 16, wherein the median particle size is greater than 8 microns.

18. The film according to claim 1, wherein the core layer is foamed during extrusion of the film by means of a chemical blowing agent, such that the film has enhanced roughness and higher vapor transmission in comparison with a non-foamed material.

19. The film according to claim 16, wherein the core layer is foamed with an endothermic blowing agent.

20. The film according to claim 1, wherein the outer layer comprises medium molecular weight high density polyethylene.
